(19) United States
(12) Patent Application Publication
(10) Pub. No.: US 2020/0410485 A1
(43) Pub. Date: Dec. 31, 2020

(54) SYSTEM, SERVER, AND METHOD

(71) Applicant: TOSHIBA TEC KABUSHIKI KAISHA, Tokyo (JP)

(72) Inventor: Yuki Matsumoto, Tagata Shizuoka (JP)

(21) Appl. No.: 16/709,085

(22) Filed: Dec. 10, 2019

(30) Foreign Application Priority Data
Jun. 25, 2019 (JP) 2019-116982

(51) Int. Cl. G06Q 20/38; G10L 15/26; G10L 15/22; G06Q 20/20

(52) U.S. Cl. CPC G06Q 20/387; G06Q 20/206; G10L 15/22; G10L 15/26

(57) ABSTRACT

According to one embodiment, a server includes a privilege information unit that stores customer-specified information that specifies a customer and privilege-specified information that specifies a privilege in association with each other, a keyword issuing unit that issues a keyword in response to a request from an information terminal, an associating unit that associates the issued keyword with the customer-specified information, a first keyword transmitting unit that transmits the issued keywords to the information terminal, and a privilege information transmitting unit that transmits privilege information extracted based on the keyword received from an order terminal to the order terminal which transmitted the keyword, in which the information terminal includes a keyword requesting unit that requests the server to issue a keyword, and a keyword display unit that displays the issued keyword, and the order terminal includes a second keyword transmitting unit that transmits the input keyword to the server, and a privilege display unit that displays the privilege information received from the server so as to be designatable.

### CROSS-REFERENCE TO RELATED APPLICATION

This application is based upon and claims the benefit of priority from Japanese Patent Application No. 2019-116982, filed in Jun. 25, 2019, the entire contents of which are incorporated herein by reference.

### FIELD

An embodiment described herein relates to a system, a server, and a method.

### BACKGROUND

In the related art, in stores such as restaurants, for example, when a customer uses a privilege such as a coupon displayed on an information terminal such as a smartphone, the customer displays the privilege at the time of payment processing, and a clerk of the store confirms the displayed privilege and performs a payment operation.

Therefore, the payment processing takes time and is a burden on the clerk.

### DESCRIPTION OF THE DRAWINGS

FIG. 1 is a diagram showing a system according to an embodiment;

FIG. 2 is a block diagram showing a hardware configuration of an information terminal;

FIG. 3 is a block diagram showing a hardware configuration of a server;

FIG. 4 is a memory map showing a configuration of an associating unit;

FIG. 5 is a memory map showing a configuration of a privilege information unit;

FIG. 6 is a block diagram showing a hardware configuration of an order terminal;

FIG. 7 is a functional block diagram showing a functional configuration of the system;

FIG. 8 is a flowchart showing a flow of control processing of the information terminal;

FIG. 9 is a diagram showing an example of a display screen of the information terminal;

FIG. 10 is a diagram showing another example of the display screen of the information terminal;

FIG. 11 is a flowchart showing a flow of server control processing;

FIG. 12 is a flowchart showing a flow of control processing of the order terminal;

FIG. 13 is a diagram showing an example of a display screen of the order terminal;

FIG. 14 is a diagram showing another example of the display screen of the order terminal; and

FIG. 15 is a diagram showing still another example of the display screen of the order terminal.

### DETAILED DESCRIPTION

Embodiments provide a system, a server, and a method capable of using a privilege without placing a burden on a clerk.

In general, according to one embodiment, a system includes an information terminal that is carried by a customer, an order terminal for inputting order information of a commodity, and a server that stores privilege information relating to the commodity, in which the server includes a privilege information unit that stores customer-specified information that specifies a customer and privilege-specified information that specifies a privilege in association with each other, a keyword issuing unit that issues a keyword in response to a request from the information terminal, an associating unit that associates the issued keyword with the customer-specified information, a first keyword transmitting unit that transmits the issued keyword to the information terminal, and a privilege information transmitting unit that transmits the privilege information extracted based on the keyword received from the order terminal to the order terminal which transmitted the keyword, the information terminal includes a keyword requesting unit that requests the server to issue a keyword, and a keyword display unit that displays the issued keywords, and the order terminal includes a second keyword transmitting unit that transmits the input keyword to the server, and a privilege display unit that displays the privilege information received from the server so as to be designatable.

Hereinafter, an embodiment will be described with reference to drawings. In the embodiment, a store is, for example, one of a plurality of chain stores of a restaurant. The present exemplary embodiment is not limited to the embodiment described below.

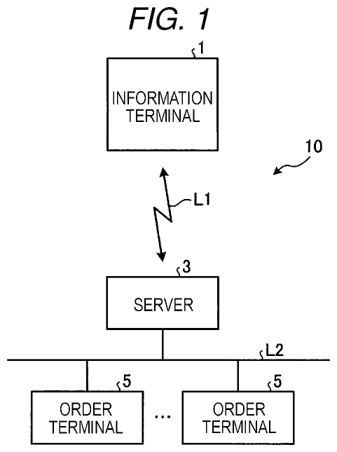

FIG. 1 is a diagram showing a system 10 according to the embodiment. The system 10 includes an information terminal 1, a server 3, and an order terminal 5. The information terminal 1 and the server 3 are connected via a communication line L1 such as the Internet. The server 3 and the order terminal 5 are connected via a communication line L2 such as a local area network (LAN), a wireless LAN, and a dedicated line.

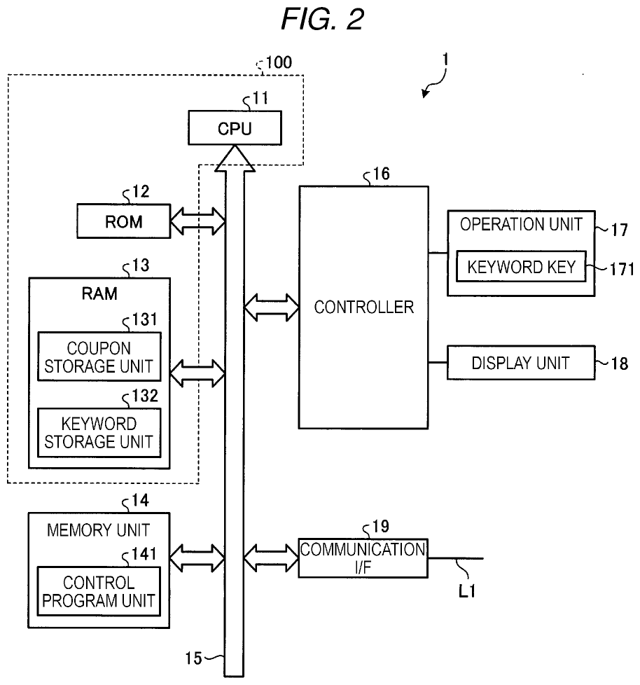

The information terminal 1 is a terminal device that can be carried by a person, such as a mobile phone, a smartphone, or a personal digital assistant (PDA). The information terminal 1 includes a display unit 18 (see FIG. 2) and displays information on the display unit 18. By installing application software for using a coupon (an example of a privilege), the information terminal 1 acquires information related to the coupon from the server 3 via the communication line L1 and displays the information on the display unit 18.

By designating a specific store on the application software, the information terminal 1 displays coupons which can be used at the store. The information terminal 1 designates one or a plurality of coupons that a customer wants to use from the available coupons. The designated coupon includes one or both of a coupon that can be used only at the store and a coupon that can be used in common at all stores. A coupon code (privilege-specified information) that specifies the designated coupon is transmitted to the server 3 via the communication line L1 together with a member code (customer-specified information) that specifies the customer who is a member.

The server 3 is installed at the headquarters of a company that manages chain stores, for example. The server 3 receives the sales of each store from the store and manages the sales for each store. The server 3 stores coupon information on coupons that can be used only at specific stores. The server 3 stores coupon information on coupons that can be used in common at all stores.

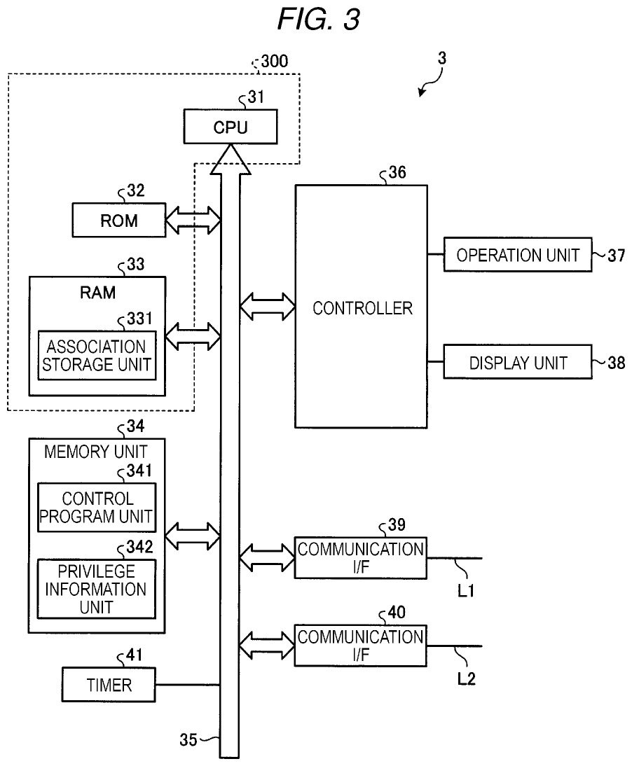

Based on the coupon code and member code received from the information terminal 1, the server 3 stores all received coupon codes in an association storage unit 331 (see FIG. 3) in association with a member code.

The server 3 issues a one-time keyword in response to a request from the information terminal 1. The server 3 associates the issued one-time keyword with the member code stored in the association storage unit 331 based on the member code received at the same time. The server 3 transmits the issued one-time keyword to the information terminal 1. When a predetermined time elapses since the server 3 issues a one-time keyword, the server 3 deletes the one-time keyword, and the association of the one-time keyword with the member code disappears.

The information terminal 1 displays the one-time keyword received from the server 3 on the display unit 18.

The server 3 extracts coupon information on all coupon codes stored in the association storage unit 331 in association with the member code associated with the one-time keyword, and transmits the coupon information to the order terminal 5 based on the one-time keyword received from the order terminal 5.

The order terminal 5 is provided, for example, on all tables installed in the store. The order terminal 5 is a device that is operated by a customer when ordering commodities for sale in the store. A customer seated at the table operates the order terminal 5 to order a desired commodity. Information on the ordered commodity is transmitted to a station server (not shown) installed in the store and used for cooking and settlement of the commodity.

The one-time keyword displayed on the information terminal 1 is input to the order terminal 5. The input of the one-time keyword to the order terminal 5 is performed by using, for example, a customer's voice. When the customer reads out the one-time keyword displayed on the information terminal 1 by voice, the voice information is input to the order terminal 5. The order terminal 5 recognizes a one-time keyword related to the input voice information by executing known voice recognition processing on the input voice information. The order terminal 5 transmits the recognized one-time keyword to the server 3 together with a store code for specifying a store.

The order terminal 5 displays the coupon information received from the server 3. The displayed coupon information can be designated for use. When a customer uses a coupon for ordering a commodity, the customer designates a coupon to be used from the displayed coupon information. When a coupon is designated, the order terminal 5 transmits the coupon information of the designated coupon to the station server together with the order information of the commodity.

The station server stores the order information of the commodity and the coupon information of the designated coupon in association with each other. The station server transmits the order information of the commodity information and the coupon information to a point of sales (POS) terminal (not shown) which performs the settlement of food and drink. When settling the commodity, the POS terminal performs the settlement processing by reflecting the associated coupon information (for example, discounting a certain amount).

Hereinafter, the hardware of the information terminal 1 will be described. FIG. 2 is a block diagram showing a hardware configuration of the information terminal 1. As shown in FIG. 2, the information terminal 1 includes a central processing unit (CPU) 11, a read-only memory (ROM) 12, a random-access memory (RAM) 13, a memory unit 14, and the like. The CPU 11 is a control subject. The ROM 12 stores various programs. The RAM 13 loads various pieces of data. The memory unit 14 stores various programs. The CPU 11, the ROM 12, the RAM 13, and the memory unit 14 are connected to one another via a data bus 15. The CPU 11, the ROM 12, and the RAM 13 constitute a control unit 100. That is, the control unit 100 executes control processing of the information terminal 1 described later by the CPU 11 operating according to the control program stored in the ROM 12 or the memory unit 14 and loaded in the RAM 13.

The RAM 13 includes a coupon storage unit 131 and a keyword storage unit 132. The coupon storage unit 131 stores coupon information on all coupons that can be used by installing application software. The coupon information stored in the coupon storage unit 131 is stored in association with store information on stores where the coupon can be used. Coupons which can be used at all stores are stored in association with information indicating that effect. The keyword storage unit 132 stores the one-time keyword received from the server 3.

The memory unit 14 includes a control program unit 141. The control program unit 141 stores a program for controlling the information terminal 1.

The control unit 100 is connected to an operation unit 17 and the display unit 18 via the data bus 15 and a controller 16. The operation unit 17 is a keyboard including a keyword key 171. The keyword key 171 is a key operated by the customer when requesting to issue a one-time keyword.

The display unit 18 is a liquid crystal display, for example, and displays information to the customer. The display unit 18 displays the one-time keyword received from the server 3. The operation unit 17 is a touch panel keyboard provided on the display unit 18.

The control unit 100 is connected to a communication I/F 19 via the data bus 15. The communication I/F 19 is connected to the server 3 via the communication line L1 and exchanges information with the server 3.

Hereinafter, the hardware of the server 3 will be described. FIG. 3 is a block diagram showing a hardware configuration of the server 3. As shown in FIG. 3, the server 3 includes a CPU 31, a ROM 32, a RAM 33, a memory unit 34, and the like. The CPU 31 is a control subject. The ROM 32 stores various programs. The RAM 33 loads various pieces of data. The memory unit 34 stores various programs. The CPU 31, the ROM 32, the RAM 33, and the memory unit 34 are connected to one another via a data bus 35. The CPU 31, the ROM 32, and the RAM 33 constitute a control unit 300. That is, the control unit 300 executes control processing of the server 3 described later by the CPU 31 operating according to the control program stored in the ROM 32 or the memory unit 34 and loaded in the RAM 33.

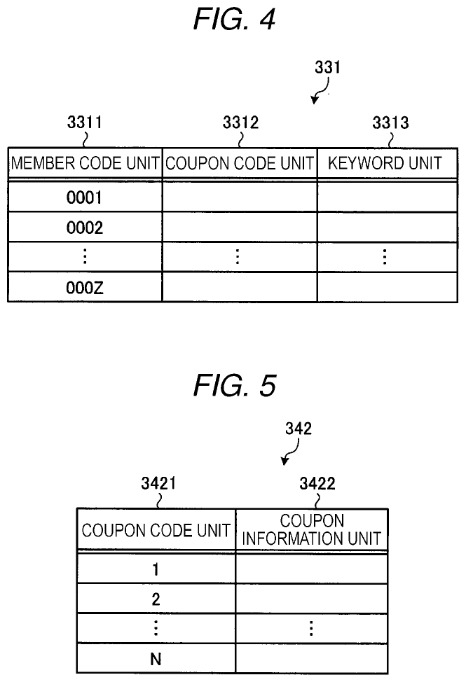

The RAM 33 includes the association storage unit 331. The association storage unit 331 stores a member code that specifies a member and a coupon code that is received from the information terminal 1 and specifies a coupon designated by the member as a coupon that may be used, in association with each other. The association storage unit 331 will be described later with reference to FIG. 4.

The memory unit 34 includes a control program unit 341 and a privilege information unit 342. The control program unit 341 stores a program for controlling the server 3. The privilege information unit 342 stores a coupon code and coupon information in association with each other. The privilege information unit 342 will be described later with reference to FIG. 5.

The control unit 300 is connected to an operation unit 37 and a display unit 38 via the data bus 35 and a controller 36. The operation unit 37 is a keyboard. The display unit 38 is a liquid crystal display, for example, and displays information to an operator.

The control unit 300 is connected to a communication I/F 39 and a communication I/F 40 via the data bus 35. The communication I/F 39 is connected to the information terminal 1 via the communication line L1 and exchanges information with the information terminal 1. The communication I/F 40 is connected to the order terminal 5 via the communication line L2 and exchanges information with the order terminal 5. The control unit 300 is connected to a timer 41 via the data bus 35. The timer 41 measures the time after starting.

Next, the association storage unit 331 will be described. The association storage unit 331 includes a member code unit 3311, a coupon code unit 3312, and a keyword unit 3313. The member code unit 3311 stores the member code. The coupon code unit 3312 stores the coupon code received from the information terminal 1 in association with the member code stored in the member code unit 3311, together with the member code. The keyword part 3313 stores a one-time keyword in association with the member code stored in the member code unit 3311. That is, when a one-time keyword is specified, an associated member code is specified. When a member code is specified, one associated coupon code or a plurality of associated coupon codes are specified.

Next, the privilege information unit 342 will be described. The privilege information unit 342 stores information on coupons that can be used at any one store of the chain stores and coupons that can be used in common at all stores. The privilege information unit 342 includes a coupon code unit 3421 and a coupon information unit 3422. The coupon code unit 3421 stores a coupon code for specifying a coupon. The coupon information unit 3422 stores coupon information (coupon logo, coupon name, privilege information (for example, discount amount, the number of given points, commodities offered free of charge, and the like) given by the coupon) specified by the coupon code stored in the coupon code unit 3421.

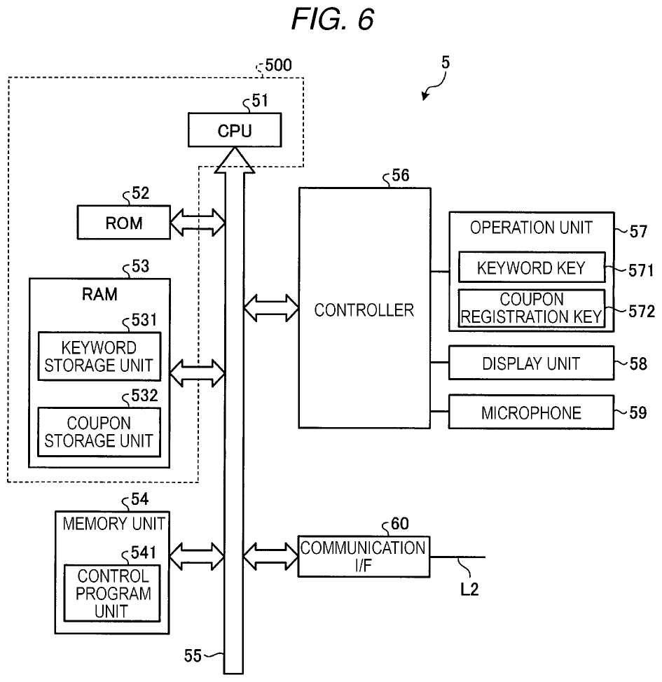

Hereinafter, the hardware of the order terminal 5 will be described. FIG. 6 is a block diagram showing a hardware configuration of the order terminal 5. As shown in FIG. 6, the order terminal 5 includes a CPU 51, a ROM 52, a RAM 53, a memory unit 54, and the like. The CPU 51 is a control subject. The ROM 52 stores various programs. The RAM 53 loads various pieces of data. The memory unit 54 stores various programs. The CPU 51, the ROM 52, the RAM 53, and the memory unit 54 are connected to one another via a data bus 55. The CPU 51, the ROM 52, and the RAM 53 constitute a control unit 500. That is, the control unit 500 executes the control processing of the order terminal 5 described later by the CPU 51 operating according to the control program stored in the ROM 52 and the memory unit 54 and loaded in the RAM 53.

The RAM 53 includes a keyword storage unit 531 and a coupon storage unit 532. The keyword storage unit 531 stores a one-time keyword as a result of voice recognition based on voice information input by voice from a microphone 59 described later. The coupon storage unit 532 stores the coupon information received from the server 3.

The memory unit 54 includes a control program unit 541. The control program unit 541 stores a program for controlling the order terminal 5.

The control unit 500 is connected to an operation unit 57, a display unit 58, and the microphone 59 via the data bus 55 and a controller 56. The operation unit 57 is a keyboard including an order transmission key 571 and a coupon registration key 572. The order transmission key 571 is a key operated when the customer places an order for a commodity to be ordered to the station server. The coupon registration key 572 is a key operated when a one-time keyword is input by voice. The display unit 58 is a liquid crystal display, for example, and displays information to the customer. The microphone 59 inputs voice spoken by the customer. When the customer inputs the one-time keyword by voice, the customer operates the coupon registration key 572 and speaks the one-time keyword displayed on the information terminal 1 to the microphone 59.

The control unit 500 is connected to a communication I/F 60 via the data bus 55. The communication I/F 60 is connected to the server 3 via the communication line L2 and exchanges information with the server 3.

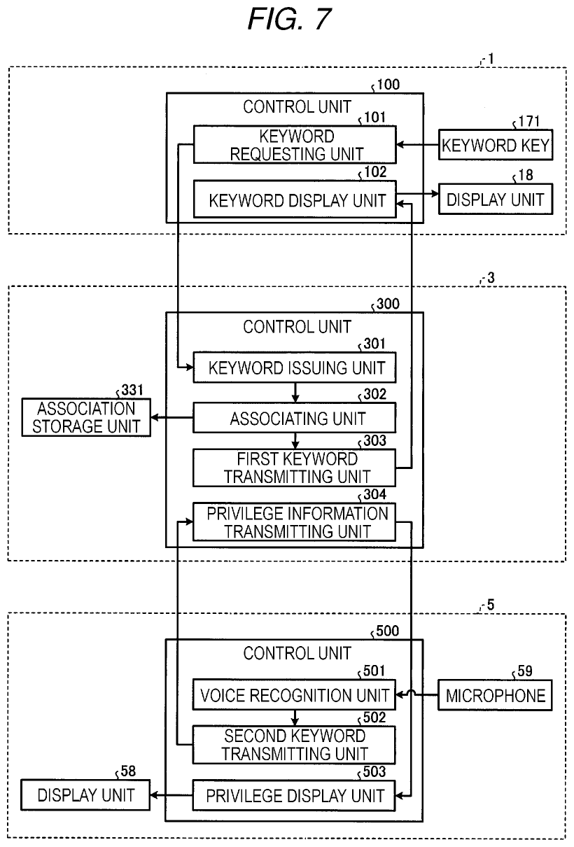

Hereinafter, the functional configuration of the system 10 will be described. FIG. 7 is a functional block diagram showing a functional configuration of the system 10. The control unit 100 of the information terminal 1 in the system 10 functions as a keyword requesting unit 101 and a keyword display unit 102 by following the control program stored in the ROM 12 or the memory unit 14 and loaded in the RAM 13.

The keyword requesting unit 101 requests the server 3 to issue a one-time keyword. Specifically, the keyword requesting unit 101 requests the server 3 to issue a one-time keyword when the keyword key 171 displayed on the display unit 18 is operated.

The keyword display unit 102 displays the issued one-time keyword. Specifically, the keyword display unit 102 receives the one-time keyword issued by the server 3 and displays the one-time keyword on the display unit 18.

The control unit 300 of the server 3 in the system 10 functions as a keyword issuing unit 301, an associating unit 302, a first keyword transmitting unit 303, and a privilege information transmitting unit 304 by following the control program stored in the ROM 32 or the memory unit 34 and loaded in the RAM 33.

The keyword issuing unit 301 issues a one-time keyword in response to a request from the information terminal 1. Specifically, the keyword issuing unit 301 issues a one-time keyword when there is a request for issuing a one-time keyword from the keyword requesting unit 101. The one-time keyword may be configured with a combination of any numerical values output from a random number table, for example. As the one-time keyword, a plurality of preset keywords may be sequentially reused. The one-time keyword can be determined in any way. The one-time keyword disappears when a predetermined time described later elapses.

The associating unit 302 associates the issued one-time keyword with the member code (customer-specified information). Specifically, the associating unit 302 stores the one-time keyword issued by the keyword issuing unit 301 in the keyword unit 3313 in association with the member code stored in the association storage unit 331. More specifically, the associating unit 302 stores the one-time keyword in the keyword unit 3313 in association with the member code transmitted by the keyword requesting unit 101 simultaneously with the request for the one-time keyword.

The first keyword transmitting unit 303 transmits the issued one-time keyword to the information terminal 1.

The privilege information transmitting unit 304 transmits the coupon information extracted based on the one-time keyword received from the order terminal 5 to the order terminal 5 which transmitted the one-time keyword.

Specifically, when the privilege information transmitting unit 304 receives the one-time keyword from the order terminal 5 and a terminal code specifying the order terminal 5, the privilege information transmitting unit 304 specifies a member code related to the one-time keyword. The privilege information transmitting unit 304 extracts the coupon information stored in the privilege information unit 342 based on the coupon code associated with the specified member code and transmits the coupon information to the order terminal 5 specified by the terminal code.

The control unit 500 of the order terminal 5 in the system 10 functions as a voice recognition unit 501, a second keyword transmitting unit 502, and a privilege display unit 503 by following the control program stored in the ROM 52 or the memory unit 54 and loaded in the RAM 53.

The voice recognition unit 501 recognizes the one-time keyword based on the voice input to the microphone 59. Specifically, the voice recognition unit 501 analyzes the voice related to the one-time keyword input to the microphone 59 and recognizes the one-time keyword.

The second keyword transmitting unit 502 transmits the input one-time keyword to the server 3. Specifically, the second keyword transmitting unit 502 transmits the one-time keyword recognized by the voice recognition unit 501 to the server 3.

The privilege display unit 503 displays the coupon information received from the server 3 on the display unit 58 so that the coupon information can be designated. The customer designates and uses the coupon information displayed on the display unit 58.

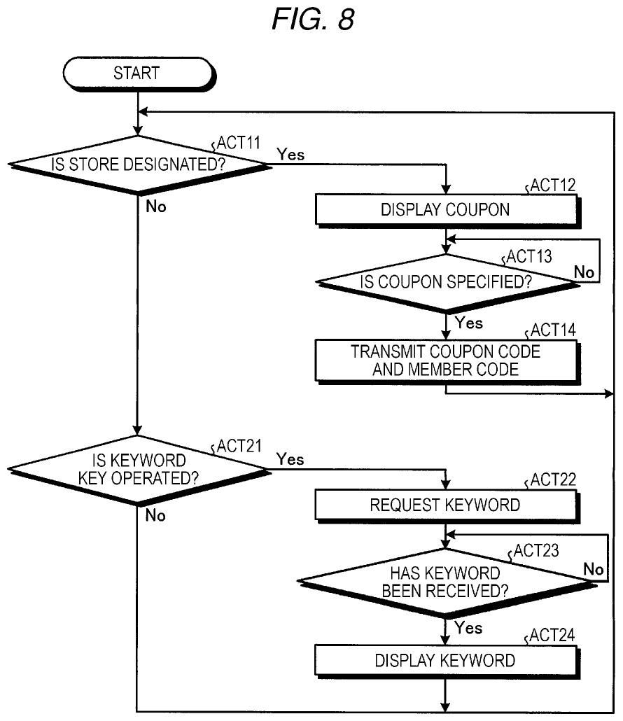

Hereinafter, the control of the information terminal 1 will be described. FIG. 8 is a flowchart showing the flow of control processing of the information terminal. As shown in FIG. 8, the control unit 100 of the information terminal 1 determines whether a store is designated (ACT 11). The designation of a store is performed by, for example, specifying one store from a plurality of stores displayed in a form of a list. If it is determined that the store is designated (Yes in ACT 11), the control unit 100 displays coupon information of coupons that can be used at the designated store (ACT 12).

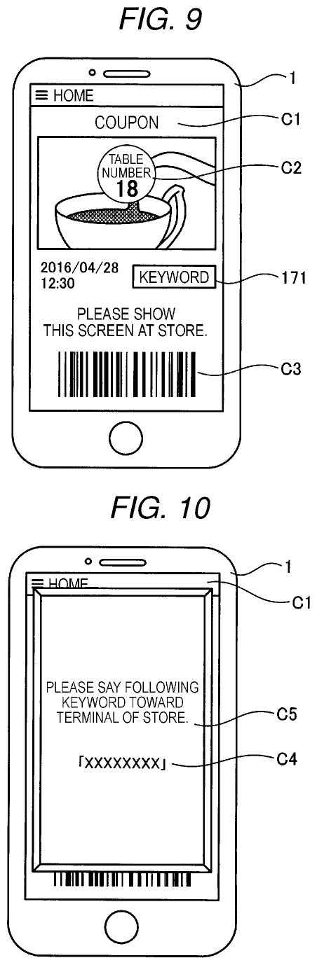

FIG. 9 shows an example of coupon information displayed in ACT 12. The display unit 18 of the information terminal 1 displays a coupon C1 that can be used at the selected store. The display unit 18 displays a coupon code C2 (number “18” in FIG. 9) for specifying a coupon and a code symbol C3 such as a barcode including coupon information. The display unit 18 displays the keyword key 171 that is operated when the server 3 is requested to issue a one-time keyword. Coupon information of coupons that can be used at the designated store is listed as a list, for example, and coupon information of the coupon designated from the list is displayed as shown in FIG. 9.

Referring back to the description of FIG. 8, next, the control unit 100 determines whether a coupon that may be used by the customer is specified from the coupons that can be used at the designated store (ACT 13), and the customer designates a coupon that may be used at the store from the listed coupons. The control unit 100 waits until the coupon that may be used at the store is designated (No in ACT 13), and if it is determined that the coupon that may be used at the store is designated (Yes in ACT 13), the control unit 100 transmits a coupon code that specifies the designated coupon and a member code to the server 3 (ACT 14). Then, the control unit 100 returns to ACT 11.

If it is determined that the store is not designated (No in ACT 11), the control unit 100 determines whether the keyword key 171 is operated (ACT 21). If it is determined that the keyword key 171 is operated (Yes in ACT 21), the keyword requesting unit 101 transmits a signal requesting to issue a one-time keyword and a member code to the server 3 (ACT 22). Next, the control unit 100 determines whether a one-time keyword is received from the server 3 (ACT 23). The keyword display unit 102 waits until a one-time keyword is received from server 3 (No in ACT 23). If it is determined that a one-time keyword is received from server 3 (Yes in ACT 23), the keyword display unit 102 displays the one-time keyword issued by the server 3 on the display unit 18 (ACT 24). Then, the control unit 100 returns to ACT 11.

FIG. 10 shows an example of the one-time keyword displayed on the display unit 18 in ACT 24. As shown in FIG. 10, the display unit 18 displays a one-time keyword C4. The one-time keyword C4 is a keyword for specifying a member because the keyword is associated with the member code in ACT 43 described later. The display unit 18 displays a message C5 for prompting voice input of the one-time keyword C4 to the order terminal 5.

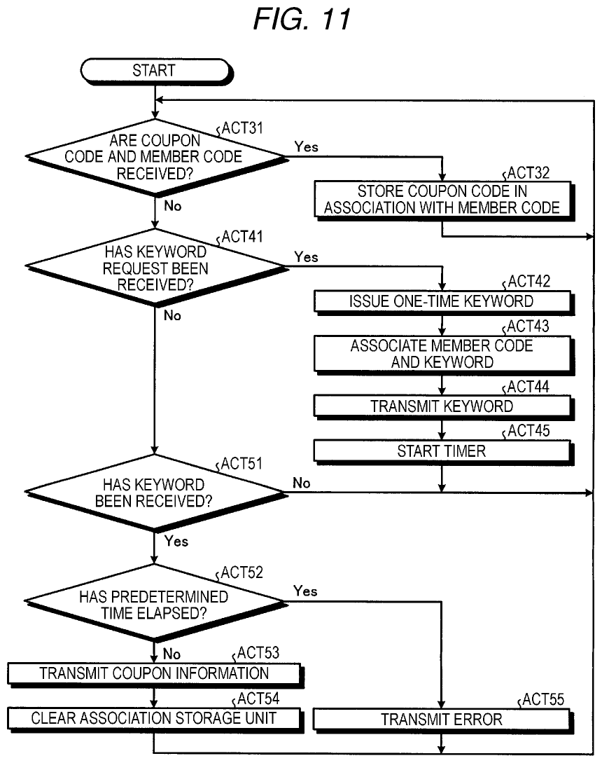

Next, control of the server 3 will be described. FIG. 11 is a flowchart showing the flow of control processing of the server 3. As shown in FIG. 11, the control unit 300 of the server 3 determines whether a coupon code and a member code are received from the information terminal 1 (ACT 31). When it is determined that the coupon code and the member code are received from the information terminal 1 (Yes in ACT 31), the control unit 300 stores the received member code in the member code unit 3311 (ACT 32). Also, the control unit 300 stores the received coupon code in the coupon code unit 3312 in association with the member code stored in the member code unit 3311 (ACT 32). The coupon code unit 3312 stores all coupon codes received together with the member code. Then, the control unit 300 returns to ACT 31.

If it is determined that the coupon code and the member code are not received (No in ACT 31), the control unit 300 determines whether a signal requesting a keyword and a member code are received from the information terminal 1 (ACT 41). If it is determined that the signal requesting a keyword and the member code are received from the information terminal 1 (Yes in ACT 41), the keyword issuing unit 301 issues a one-time keyword in response to a request from the information terminal 1 (ACT 42).

Next, the associating unit 302 associates the issued one-time keyword with the member code by storing the issued one-time keyword in the keyword unit 3313 in association with the received member code (ACT 43). Then, the first keyword transmitting unit 303 transmits the issued one-time keyword to the information terminal 1 requested to issue the one-time keyword (ACT 44). Next, the control unit 300 starts the timer 41 (ACT 45). Then, the control unit 300 returns to ACT 31.

If it is determined that the signal requesting a keyword and the member code are not received from the information terminal 1 (No in ACT 41), the control unit 300 determines whether the one-time keyword and the terminal code are received from the order terminal 5 (ACT 51). If it is determined that the one-time keyword and the terminal code are received from the order terminal 5 (Yes in ACT 51), the control unit 300 determines whether a predetermined time (for example, 5 minutes) elapses since the timer 41 is started in ACT 45 (ACT 52). If it is determined that the predetermined time does not elapse (No in ACT 52), the privilege information transmitting unit 304 transmits the coupon information extracted based on the received one-time keyword to the order terminal 5 specified by the received terminal code (ACT 53). Then, the control unit 300 clears the member code, the coupon code, and the one-time keyword of the associating unit 331 involved in the transmission of the coupon information (ACT 54).

On the other hand, if it is determined that the predetermined time elapses since the timer 41 is started in ACT 45 (Yes in ACT 52), error information is transmitted to the order terminal 5 specified by the received terminal code (ACT 55). In the embodiment, when the server 3 does not receive the one-time keyword from the order terminal 5 within the predetermined time since the one-time keyword is sent, the coupon is not sent. This is to maintain security in distributing coupons. That is, when the customer transmits a coupon code in ACT 14 and does not transmit the one-time keyword from the order terminal 5 as it is, this is to avoid storage of the member code, the coupon code, and the one-time keyword in association with one another. When the customer wants to use a coupon, it is necessary to transmit a one-time keyword from the order terminal 5 to the server 3 within a predetermined time since the information terminal 1 displays the one-time keyword.

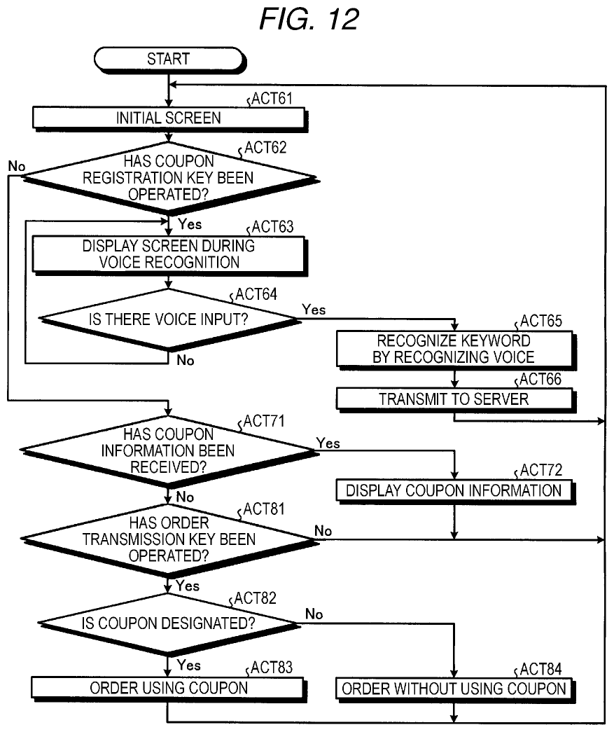

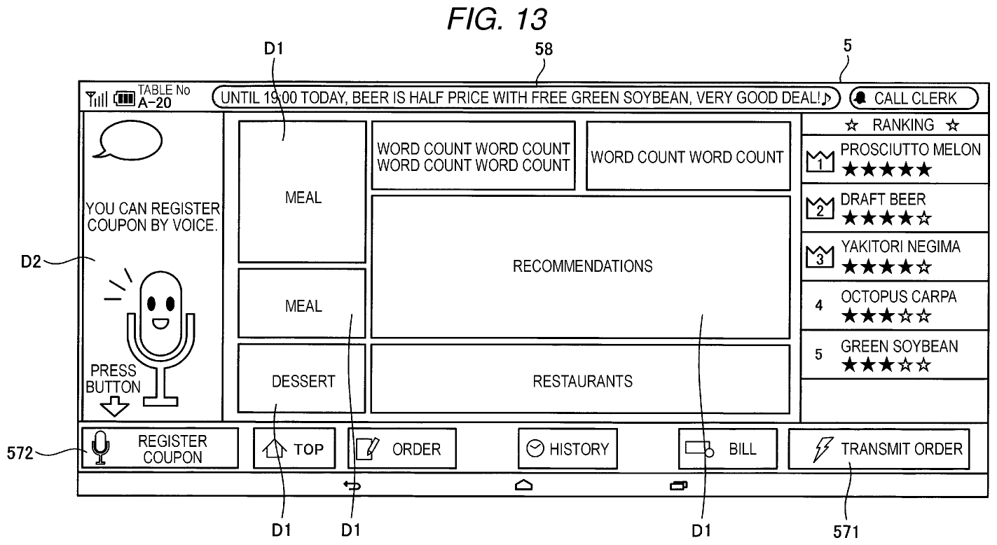

Hereinafter, control of the order terminal 5 will be described. FIG. 12 is a flowchart showing a flow of control processing of the order terminal 5. As shown in FIG. 12, the control unit 500 of the order terminal 5 displays an initial screen on the display unit 58 (ACT 61). FIG. 13 shows an example of the initial screen displayed in ACT 61. As shown in FIG. 13, the display unit 58 of the order terminal 5 displays a menu D1 for selecting a commodity to be ordered by the customer, a message D2 for prompting voice input of a one-time keyword, the order transmission key 571 for placing an order for a commodity to be ordered, and the coupon registration key 572 used when inputting a one-time keyword by voice and acquiring a coupon.

Referring back to the description of FIG. 12, next, the control unit 500 determines whether the coupon registration key 572 is operated (ACT 62). If it is determined that the coupon registration key 572 is operated (Yes in ACT 62), the control unit 500 displays a screen during voice recognition and waits for voice input (ACT 63).

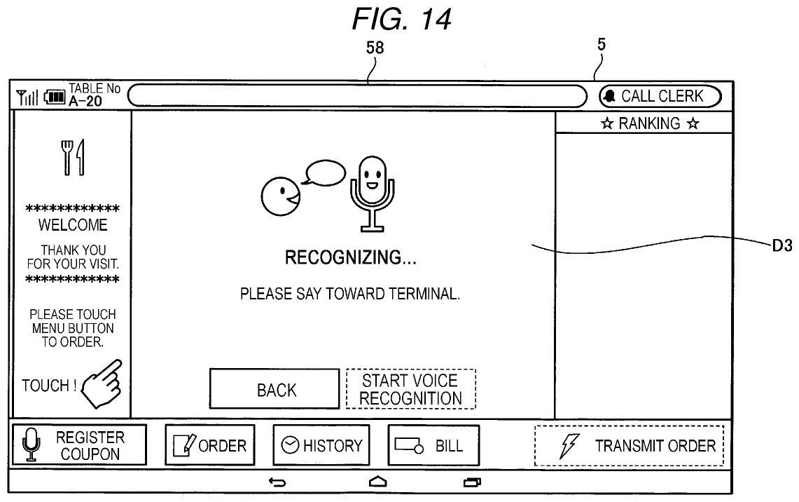

FIG. 14 shows an example of a screen during voice recognition in ACT 63. As shown in FIG. 14, the display unit 58 displays that a voice is being recognized and displays a message D3 for prompting voice input. While the message D3 is displayed, the customer inputs the one-time keyword by speaking the one-time keyword toward the microphone 59 by voice.

Referring back to the description of FIG. 12, the control unit 500 determines whether a voice is input from the microphone 59 (ACT 64). If it is determined that the voice is input from the microphone 59 (Yes in ACT 64), the voice recognition unit 501 recognizes the one-time keyword based on the voice input to the microphone 59. (ACT 65). The control unit 500 stores the recognized one-time keyword in the keyword storage unit 531. Then, the second keyword transmitting unit 502 transmits the one-time keyword stored in the keyword storage unit 531 and the terminal code for specifying the order terminal 5 to the server 3 (ACT 66). Then, the control unit 500 returns to ACT 61. While no voice is input from the microphone 59 (No in ACT 64), the control unit 500 returns to ACT 63 and continues to display the screen during voice recognition.

If it is determined that the coupon registration key 572 is not operated (No in ACT 62), the control unit 500 determines whether coupon information is received from the server 3 (ACT 71). If it is determined that the coupon information is received from the server 3 (Yes in ACT 71), the privilege display unit 503 displays the received coupon information on the display unit 58 so that the coupon information can be designated (ACT 72). Then, the control unit 500 returns to ACT 61.

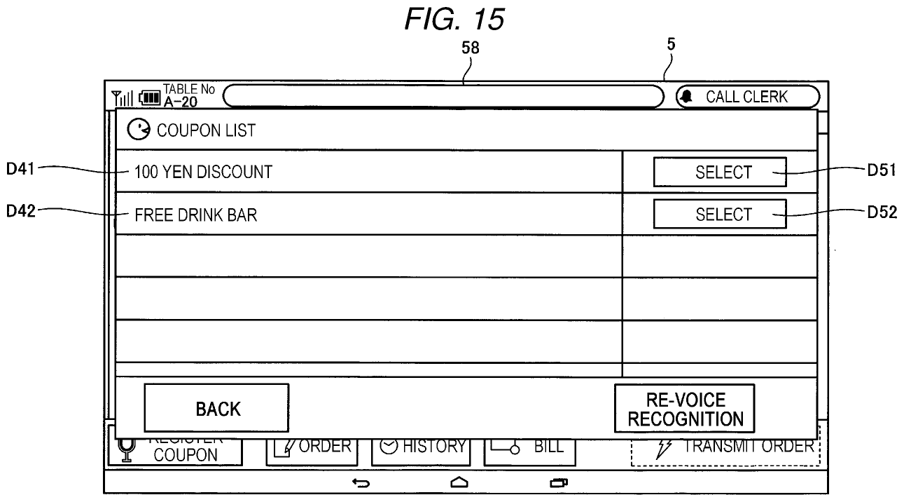

FIG. 15 shows an example of coupon information displayed on the display unit 58. As shown in FIG. 15, on the display unit 58, for example, coupon information D41 of “100 YEN DISCOUNT” and coupon information D42 of “FREE DRINK BAR” are displayed. The customer designates two types of coupons that can be used at the store in ACT 13, and as a result, the two types of coupon information related to the coupons are displayed as the coupon information D41 and the coupon information D42.

On the display unit 58, a key D51 is displayed in association with the coupon information D41, and a key D52 is displayed in association with the coupon information D42. The key D51 is a key for designating use of a coupon related to the coupon information D41. The key D52 is a key for designating use of the coupon related to the coupon information D42. The customer operates the key D51 when using the coupon related to the coupon information D41. The customer operates the key D52 when using the coupon related to the coupon information D42.

Referring back to the description of FIG. 12, if it is determined that the coupon information is not received from the server 3 (No in ACT 71), the control unit 500 determines whether the order transmission key 571 is operated (ACT 81). If it is determined that the order transmission key 571 is operated (Yes in ACT 81), the control unit 500 determines whether a coupon is designated (ACT 82). If it is determined that a coupon is designated (Yes in ACT 82), the control unit 500 transmits the coupon information of the designated coupon to the station server together with the order information of the commodity (ACT 83). Then, the control unit 500 returns to ACT 61. If it is determined that no coupon is designated (No in ACT 82), the control unit 500 transmits only the order information of the commodity to the station server (ACT 84). Then, the control unit 500 returns to ACT 61.

If it is determined that the order transmission key 571 is not operated (No in ACT 81), the control unit 500 returns to ACT 61.

According to the system 10 of such an embodiment, the server 3 includes the privilege information unit 342 that stores a member code and a coupon code in association with each other, the keyword issuing unit 301 that issues a keyword in response to a request from the information terminal 1, the associating unit 302 that associates the issued one-time keyword with member-specified information, the first keyword transmitting unit 303 that transmits the issued one-time keyword to the information terminal 1, and the privilege information transmitting unit 304 that transmits coupon information extracted based on the one-time keyword received from the order terminal 5 to the order terminal 5 which transmitted the one-time keyword, the information terminal 1 includes the keyword requesting unit 101 that requests the server 3 to issue a one-time keyword and the keyword display unit 102 that displays the issued one-time keyword, and the order terminal 5 includes the second keyword transmitting unit 502 that transmits the input one-time keyword to the server 3 and the privilege display unit 503 that displays coupon information received from the server 3 so that the coupon information can be designated. Therefore, the customer designates a coupon to be used based on the coupon information displayed on the order terminal 5 when ordering a commodity. Therefore, the coupon can be used without placing a burden on a clerk.

According to the server 3 of such an embodiment, the server includes the privilege information unit 342 that stores member-specified information that specifies a member and privilege-specified information that specifies a privilege in association with each other, the keyword issuing unit 301 that issues a one-time keyword in response to a request from the information terminal 1, the associating unit 302 that associates the issued one-time keyword with the member-specified information, the first keyword transmitting unit 303 that transmits the issued one-time keyword to the information terminal 1, and the privilege information transmitting unit 304 that transmits coupon information extracted based on the one-time keyword received from the order terminal 5 to the order terminal 5 which transmitted the one-time keyword so that the coupon information can be displayed. Therefore, the customer can designate a coupon to be used based on the coupon information displayed on the order terminal 5 when ordering a commodity. Therefore, the coupon can be used without placing a burden on the clerk.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, a store is designated on the information terminal 1, and coupons which can be used at the store are narrowed down in advance. The present exemplary embodiment is not limited thereto, and the customer may designate a coupon to be used without designating a store on the information terminal 1, the order terminal 5 may transmit a store code that specifies a store where the order terminal 5 is installed together with the terminal code when the order terminal 5 transmits the one-time keyword to the server 3, and the server 3 may extract coupon information corresponding to the coupon code specified by the store code from the coupon code stored in the coupon code unit 3312 and transmits the coupon information to the order terminal 5.

In the embodiment, the order terminal 5 is assumed to be placed on a table in a store. However, the present exemplary embodiment is not limited thereto, and the order terminal 5 may be placed at a place other than the table in the store.

The embodiment has been described by using coupon information as an example of privilege information. However, the present exemplary embodiment is not limited thereto, and the privilege information may be information on a privilege for a customer, such as giving of points or provision of prizes.

In the embodiment, the one-time keyword displayed on the information terminal 1 is input to the order terminal 5 by voice input. However, the present exemplary embodiment is not limited thereto, and the one-time keyword displayed on the information terminal 1 may be input by using means other than a voice, for example, using the keyboard of the order terminal 5.

In the embodiment, the order terminal 5 displays a coupon useable at a store where food and drink is available so that the coupon can be designated. However, the present exemplary embodiment is not limited thereto, and the order terminal 5 may display a coupon that can be used at a store where food and drink is available together with coupons other than the coupon that can be used at a store where food and drink is available, as long as the coupons can be used by a member.

The program to be executed by the store server 3 of the embodiment is provided by being recorded on a computer-readable recording medium such as a CD-ROM, a flexible disk (FD), a CD-R, or a digital versatile disc (DVD) in a file of an installable format or executable format.

In addition, the program to be executed by the server 3 of the embodiment may be configured to be stored on a computer connected to a network such as the Internet and provided by being downloaded via the network. In addition, the program to be executed by the server 3 of the embodiment may be provided or distributed via a network such as the Internet.

In addition, the program to be executed by the server 3 of the embodiment may be configured to be provided by being incorporated in advance in a ROM or the like.

What is claimed is:

1. A system, comprising:
an information terminal that is handled by a customer;
an order terminal for inputting order information of a commodity; and
a server that stores privilege information relating to the commodity, wherein
the server comprises
a privilege information component that stores customer-specified information that specifies a customer and privilege-specified information that specifies a privilege in association with the customer,
a keyword issuing component that issues a keyword in response to a request from the information terminal,
an associating component that associates the issued keyword with the customer-specified information,
a first keyword transmitter that transmits the issued keyword to the information terminal, and
a privilege information transmitter that transmits the privilege information extracted based on the keyword received from the server to the order terminal which transmitted the keyword,
the information terminal comprises
a keyword requesting component that requests the server to issue a keyword, and
a keyword display that displays the issued keyword, and
the order terminal comprises
a second keyword transmitter that transmits the input keyword to the server, and
a privilege display that displays the privilege information received from the server so as to be designatable.

2. The system according to claim 1, wherein
the second keyword transmitter transmits the keyword obtained by voice recognition of an input voice to the server.

3. The system according to claim 1, wherein
the keyword issued by the keyword issuing component is a one-time keyword issued every time there is a request from the information terminal.

4. The system according to claim 1, wherein
the information terminal transmits privilege information designated from privilege information usable in a specific store to the server together with the customer-specified information, and
the associating component associates the keyword and the customer-specified information received from the information terminal with the customer-specified information.

5. The system according to claim 1, wherein
the privilege is a coupon for the commodity.

6. The system according to claim 1, wherein
the customer-specified information comprises a member code and the privilege-specified information comprises a coupon code.

7. The system according to claim 1, wherein
the information terminal is a smartphone.

8. The system according to claim 1, wherein
the information terminal and the server are connected by a local area network or a wireless local area network.

9. The system according to claim 1, further comprising a plurality of information terminals each comprising the keyword requesting component that requests the server to issue a keyword, and the keyword display that displays the issued keyword.

10. A server in a system including an information terminal that is handled by a customer, an order terminal for inputting order information of a commodity, and the server that stores privilege information relating to the commodity, the server comprising:
a privilege information component that stores customer-specified information that specifies a customer and privilege-specified information that specifies a privilege in association with each other;
a keyword issuing component that issues a keyword in response to a request from the information terminal;
an associating component that associates the issued keyword with the customer-specified information;
a first keyword transmitter that transmits the issued keyword to the information terminal; and
a privilege information transmitter that transmits the privilege information extracted based on the keyword received from the server to the order terminal which transmitted the keyword.

11. The server according to claim 10, wherein
the keyword issued by the keyword issuing component is a one-time keyword issued every time there is a request from the information terminal.

12. The server according to claim 10, wherein
the information terminal transmits privilege information designated from privilege information usable in a specific store to the server together with the customer-specified information, and
the associating component associates the keyword and the customer-specified information received from the information terminal with the customer-specified information.

13. The server according to claim 10, wherein
the privilege is a coupon for the commodity.

14. The server according to claim 10, wherein
the customer-specified information comprises a member code and the privilege-specified information comprises a coupon code.

15. A method of causing a computer as a server including a privilege information component that stores customer-specified information that specifies a customer and privilege-specified information that specifies a privilege in association with each other, in a system including an information terminal that is handled by a customer, an order terminal for inputting order information of a commodity, and the server that stores privilege information relating to the commodity, to perform the following functions:
issuing a keyword in response to a request from the information terminal;
associating the issued keyword with the customer-specified information;
transmitting the issued keyword to the information terminal; and
a privilege information transmitting unit that transmitting the privilege information extracted based on the keyword received from the server to the order terminal which transmitted the keyword.

16. The method according to claim 15, further comprising:
transmitting the keyword obtained by voice recognition of an input voice to the server.

17. The method according to claim 15, wherein
the keyword issued by the keyword issuing component is a one-time keyword issued every time there is a request from the information terminal.

18. The method according to claim 15, further comprising:
transmitting privilege information designated from privilege information usable in a specific store to the server together with the customer-specified information, and
associating the keyword and the customer-specified information received from the information terminal with the customer-specified information.

19. The method according to claim 15, wherein
the privilege is a coupon for the commodity.

20. The method according to claim 15, wherein
the customer-specified information comprises a member code and the privilege-specified information comprises a coupon code.
